(19) United States
(12) Patent Application Publication
(10) Pub. No.: US 2010/0001020 A1
(43) Pub. Date: Jan. 7, 2010

(54) METHOD OF ATTACHING A SOFT PLASTIC BAG IN AN AEROSOL CAN, AND OTHER CANS SUCH AS FLAT TOP CANS

(76) Inventor: Louis S. ASHLEY, Pleasant City, OH (US)

Correspondence Address: Hasse & Nesbitt LLC, 8837 Chapel Square Drive, Suite C, CINCINNATI, OH, 45249, US

(21) Appl. No.: 12/497,189

(22) Filed: Jul. 2, 2009

Related U.S. Application Data
(60) Provisional application No. 61/133,838, filed on Jul. 2, 2008.
(60) Provisional application No. 61/195,435, filed on Oct. 7, 2008.

(51) Int. Cl. B65D 83/14; B23P 11/00

(52) U.S. Cl. 222/95; 222/105; 29/509; 220/62.21; 222/402.1; 222/386.5

(57) ABSTRACT

The present invention is a method and apparatus for attaching a soft plastic liner within an aerosol can and other cans such as flat top cans. The bag is attached in the can by the method of entrapment, or retention. The liner is typically a thin film plastic material with a thickened bead at the open end. The liner can be made of a polyvinylchloride (PVC) material or a slightly more rigid plastic than PVC. When the dome and body are assembled, there is a cavity or pocket formed, as well as a narrow passage at the bottom of the dome. The thickened bead is entrapped in the cavity and can not pass through the narrow passage, which provides the correct space for the thin film bag. The aerosol can typically includes a bottom end and an opposing top end, the opposing top end configured to receive a valve dome, a liner comprising an open end, a closed end, a liner body disposed therebetween, wherein the open end includes a sealing bead which is thicker than the liner body and wherein said liner is disposed in said aerosol can, and a valve dome.

### CROSS-REFERENCE TO RELATED APPLICATION

This application claims the benefit of U.S. Provisional Application Nos. 61/133,838, filed on Jul. 2, 2008 and 61/195,435, filed on Oct. 7, 2008, the disclosures of which are incorporated herein by reference.

### FIELD OF INVENTION

This invention relates generally to aerosol assemblies. More specifically, this invention relates to an aerosol assembly having a liner separating the propellant from the product and methods of making the same.

### BACKGROUND OF THE INVENTION

One type of aerosol dispensing container has a collapsible liner or pouch-like structure disposed within the container. The interior of the liner defines a product chamber for holding a product to be dispensed. A propellant chamber for holding a pressurized propellant is formed between the interior of the container and the exterior of the liner. The liner has an opening for communicating with the exterior of the container via a dispensing means, typically a valve. The propellant exerts a compressive force on the liner, collapsing the liner and forcing the product therein to be dispensed from the container as the valve is actuated. Thus, the product is not contaminated by the propellant, and the propellant is not vented to the atmosphere.

Presently, insertable liners and their insertion methods have several disadvantages. Not only is the assembly process relatively slow, cumbersome and expensive due to the special steps required to prepare the liner for insertion through the valve opening, but they may also produce non-uniform surfaces and cracks, especially around the liner opening, resulting in poor sealing characteristics at the valve opening/liner interface which permit propellant and/or product leakage or permeation out of the container. Attempts to utilize a gasket or adhesive to seal the interface have not been entirely successful and also increases manufacturing costs and crimp leakage problems. Thus, a lined aerosol package that may be efficiently assembled and that also protects the product is needed.

### SUMMARY OF THE INVENTION

This invention relates to an aerosol package, comprising an aerosol container comprising a bottom end and an opposing top end, the opposing top end configured to receive a valve dome, a liner comprising a first end, a second end, and a liner body disposed therebetween, wherein the first end has an opening and a top edge that includes a sealing bead which is thicker than the liner body and wherein said liner is disposed in said top end of said aerosol container, and a valve dome.

This invention also relates to a method for assembling an aerosol package, the method comprising the steps of providing a sub-assembly comprising an aerosol container and a liner disposed therein, said aerosol container comprising a bottom end and an opposing top end, the opposing top end being configured to receive a valve dome, said liner comprising an first end, a second end, and a liner body disposed therebetween, wherein the first end has an opening and a top edge that includes a sealing bead which is thicker than the liner body, providing a valve dome, inserting said valve dome into said open end of said liner and top end of said aerosol container, wherein said sealing bead of said liner is squeezed between said valve dome and said aerosol container, thereby establishing a seal between said valve dome and said aerosol container, and affixing said valve dome to said aerosol container.

This invention further relates to a method for assembling an aerosol package, the method comprising the steps of providing a sub-assembly comprising a valve dome and a liner disposed thereon, said liner comprising a first end, a second end, and a liner body disposed therebetween, wherein the first end has an opening and a top edged that includes a sealing bead which is thicker than said liner body, said valve dome defining a groove for receiving said sealing bead of said liner, providing an aerosol container comprising a bottom end and an opposing top end including an annular rim that defines an opening into the aerosol container, the opposing top end configured to receive said valve dome and said liner, inserting said valve dome and liner subassembly into said top end of said aerosol container, wherein said sealing bead of said liner is squeezed between said valve dome and said aerosol container thereby establishing a seal between said valve dome and said aerosol container, and affixing said valve dome with said aerosol container rim.

This also relates to an aerosol package wherein the sealing bead is disposed between the valve dome and the aerosol container. The valve dome may also have a groove for receiving the sealing bead of the liner. Furthermore, the valve body may also have a sloped step that may increase the sealing ability of the sealing bead of the liner as the pressure inside the can increases.

This invention also related to an aerosol container that may utilize a rigid insert that may assist in the formation of the seal.

### BRIEF DESCRIPTION OF THE DRAWINGS

FIG. 1A is a section view of an aerosol package of the invention with a sealing mechanism that includes a sealing bead between an aerosol container and a valve dome having a groove.

FIG. 1B is an exploded view of the sealing mechanism of the aerosol package of FIG. 1A.

FIG. 1C is an exploded view of the aerosol package of FIG. 1A partially assembled.

FIG. 1D is a section view of a liner.

FIG. 2A is a section view of an aerosol package of the invention utilizing a rigid insert.

FIG. 2B is an exploded view of the sealing mechanism of the aerosol package of FIG. 2A.

FIG. 3A is a section view of an aerosol package of the invention with a sealing mechanism that includes a sealing bead between an aerosol container having a groove and a valve dome.

FIG. 3B is an exploded view of the aerosol package of FIG. 3A partially assembled.

FIG. 3C is an exploded view of the sealing mechanism of the aerosol package of FIG. 3A.

FIG. 3D is an alternative view of the aerosol package of FIG. 3A with a sealing mechanism located at the bottom end of the aerosol container.

FIG. 4A is a section view of an aerosol package of the invention with the sealing bead located midway in the aerosol container

FIG. 4B is an exploded view of FIG. 4A with the sealing bead located at the upper end of the aerosol container.

FIG. 4C is an exploded view of the bead receiving portion of the aerosol package of FIG. 4A.

FIG. 4D is an exploded view of FIG. 4A with the sealing bead located at the lower end of the aerosol container.

FIG. 5 is a section view of the aerosol package of the invention with a modified liner.

FIG. 6 is a section view of the aerosol package of the invention with a valve dome defining a groove for receiving a sealing bead.

FIG. 7A is a section view of the aerosol package utilizing a rigid insert ring.

FIG. 7B is an exploded section view of the rigid insert ring of FIG. 7A.

FIG. 7C is an exploded view of FIG. 7A with the rigid insert ring and sealing bead at the lower end of the aerosol container.

FIG. 8 is a section view of an aerosol package of the invention utilizing a rigid insert encompassing a valve body.

FIG. 9A is a section view of an aerosol package of the invention utilizing a rigid insert located midway in the aerosol container.

FIG. 9B is an exploded view of an embodiment similar to FIG. 9A utilizing an alternative rigid insert located midway in the aerosol container.

FIG. 10 is a section view of an aerosol package of the invention utilizing two rigid inserts.

FIG. 11 is a section view of a lined can assembly of the invention utilizing a flat top.

FIG. 12A is a section view of an aerosol package having a dome with a sloped step at an angle of α from vertical.

FIG. 12B is a section view of an aerosol package having a dome with a sloped step showing the initial angle of a increasing as the pressure inside the aerosol package is increased.

### DETAILED DESCRIPTION OF THE INVENTION

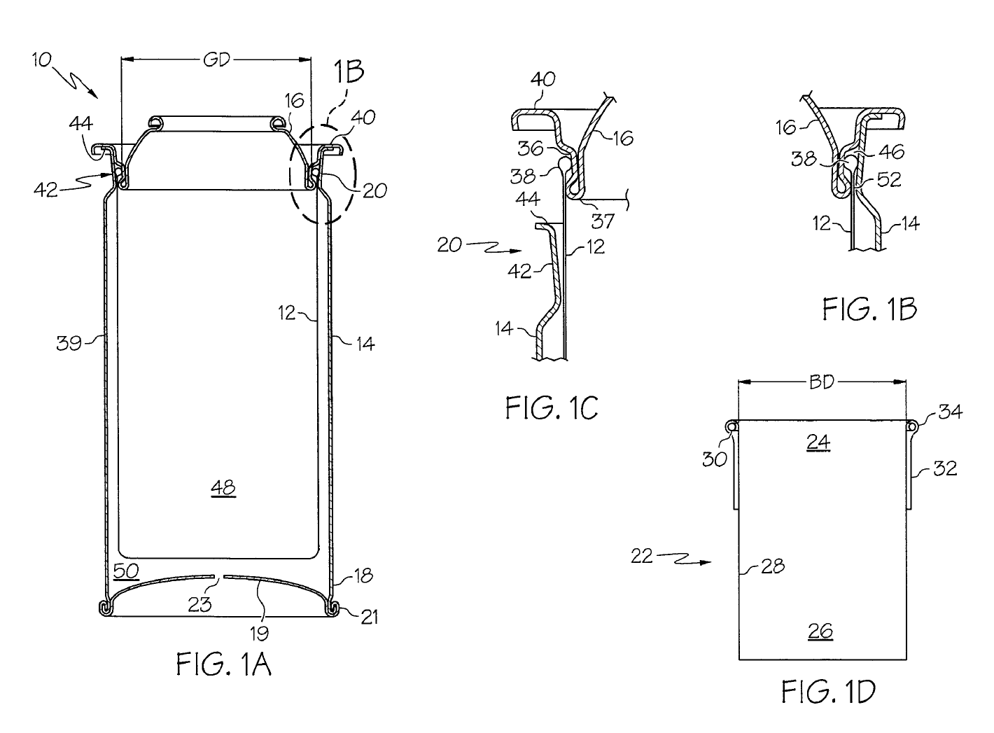

FIG. 1A illustrates an aerosol package 10 comprising a liner 12, an aerosol container 14, and a valve dome 16. As with the other embodiments described in this application, the aerosol package is typically of a cylindrical shape. The aerosol container has a bottom end 18, a container body 39, and an opposing top end 20 configured to receive valve dome 16. The bottom end 18 of the aerosol container 14 contains a dome shaped bottom 19 that is affixed to the container body 39 by a crimp 21. Other means may be used to affix the dome shaped bottom 19 to the container body 39, or the dome shaped bottom and the aerosol container may be formed from a single piece of material. The dome shaped bottom 19 has a hole 23 that is used to introduce a propellant into the propellant chamber 50 to pressurize the aerosol assembly, which is plugged afterward to prevent the propellant from escaping. Alternatively, the dome shaped bottom 19 may be a continuous structure without a hole and the propellant gas may be introduced between the valve dome 16 and the aerosol container 14. The top end 20 of aerosol container 14 contains a tapered neck portion 42 and a flange 44. The valve dome 16 also contains a flange 40.

As is typical with the liners used in this and the other embodiments described herein, the liner comprises a first end, a second end, and a liner body, wherein the first end has an opening and a top edge that includes a sealing bead. Methods that may be used for creating a liner with a sealing bead may be found in U.S. Pat. Nos. 5,932,163, 6,344,163, and 6,405,890, each of which is incorporated by reference herein in their entirety. The liner 12 shown in FIG. 1A illustrates a liner bag that may be formed through the processes described in those patents.

Referring now to FIG. 1C, there is illustrated a partially assembled aerosol package in which the valve dome 16 has an inwardly directed groove 36 for receiving the sealing bead 38 of the liner 12. The groove 36 is defined between the outwardly projecting lower rim 37 and the upper flange 40. Typically, a liner bag may be made of flexible PVC material, but other material, such as plastic films or metal foils, known to those of ordinary skill in the art may be used. The inside diameter BD (FIG. 1D) of the liner at the sealing bead is slightly less than the outside diameter GD (FIG. 1A) of the groove 36, resulting in the sealing bead 38 fitting tightly in the groove 36 so that it will not fall or roll out of the groove easily or under its own weight, but can be stretched to pass over the lower rim 37. FIG. 1B illustrates the top end 20 of the aerosol container 14 fully receiving the valve dome 16 and liner 12 sub-assembly. The groove 36 of the valve dome 16 and the tapered neck portion 42 of the aerosol container 14 cooperate to create a cavity 46. As illustrated, the sealing bead 38 may be squeezed within the cavity 46 between the groove 36 in the valve dome 16 and the inside of the neck portion 42 of the aerosol container 14, forming a seal between the product chamber 48 within liner 12 and the propellant chamber 50, between the product chamber 48 and the atmosphere, and between the propellant chamber 50 and the atmosphere (FIG. 1A). The seal is formed because, typically, the width of the cavity 46 is less than the thickness of the sealing bead 38, thus compressing the sealing bead 38. The liner 12 extends downward from the sealing bead 38 into the aerosol container 14 through a narrow passage 52 between the lower rim 37 of the valve dome 16 and the neck portion 20 of the aerosol container 14. Typically, the width of passage 52 is slightly greater than the liner thickness to prevent pinching or tearing of the liner 12 during assembly and usage of the aerosol package. During assembly, the valve dome 16 slides into an opening at the top end 20 of the aerosol container 14. As the lower rim 37 of the valve dome 16 passes through the tapered neck portion 42 of the aerosol container 14, the bead 38 is captured and squeezed tightly within the groove 36 between the valve dome 16 and the top end 20 of the aerosol container 14. This secures and seals the bead 38 within the container 14. The valve dome 16 is fully disposed within the opening of the container when flange 40 engages flange 44 of the aerosol container 14. The lower rim 37 prevents the sealing bead 38 and the liner 12 from being pulled into the aerosol container 14 after assembly.

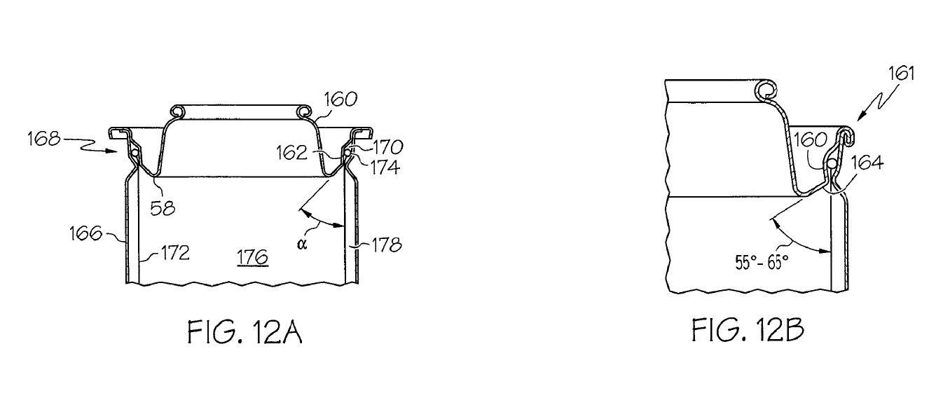

After the valve dome 16 and liner 12 are seated into the top end 20 of the aerosol container 14, the valve dome 16 may be affixed to the top end 20 of the aerosol container 14. One method of affixing the valve dome 16 to the top end 20 of the aerosol container 14 is by crimping the flange 40 of the valve dome 16 to the flange 44 of the aerosol container 14. The sealing bead 38 also creates a double seal for the crimped seam, and can prevent leakage of the propellant or product to the atmosphere if the crimped seam becomes damaged. This crimping embodiment 161 is illustrated in FIG. 12B. Other methods of affixing the valve dome 16 to the aerosol container 14 may also be used.

Another liner embodiment is illustrated in FIG. 1D. Liner 22 is a conventional plastic liner which has an open end 24, a closed end 26 and a liner body 28 disposed therebetween. Liner 22 may be made by placing an O-ring 30 over the open end 24 of liner 22 and folding the liner back over the O-ring 30, forming an outer skirt 32. Folding the liner over the O-ring creates a thickened end 34 which is thicker than the liner body 28, similar to the sealing bead 38 of FIG. 1A. This liner 22 can be used in place of the soft plastic liner 12 of FIG. 1A.

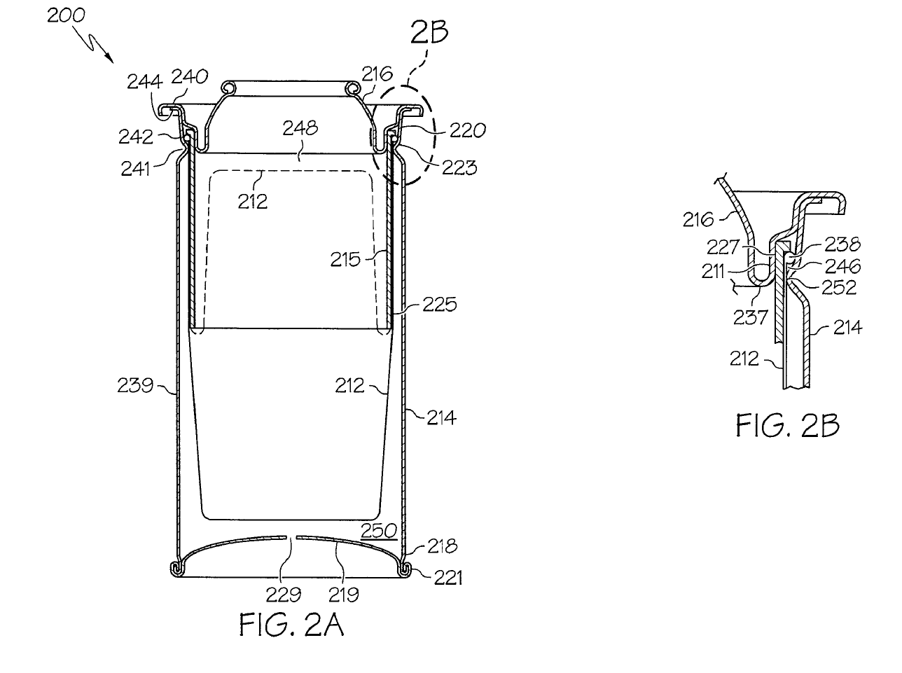

FIG. 2A illustrates another embodiment of the invention in which an aerosol package 200 has a liner 212, an aerosol container 214, a rigid insert 215, and a valve dome 216. The rigid insert 215 may extend to the approximate midpoint of the aerosol container 214. The rigid insert in this embodiment and in the other embodiments using a rigid insert may be plastic or another rigid material such as fiberglass, or aluminum. The liner 212 encompasses the rigid insert 215, the rigid insert 215 having a first end 223 and a second end 225. Referring to FIG. 2B, the first end 223 of the rigid insert 215 defines a step 227 for receiving a sealing bead 238 of the liner 212. The valve dome 216 contains a flange 240. The aerosol container 214 has a container body 239, a bottom end 218, and an opposing top end 220 configured to receive valve dome 216. The top end 220 of aerosol container 214 contains a tapered neck portion 242, a flange 244, and a step 241 rolled into the aerosol container 214 for receiving the bead 238 of the liner 212. The bottom end 218 of the aerosol container 214 contains a dome shaped bottom 219 that is affixed to the aerosol container body 139 by a crimp 221. Other means may be used to affix the dome shaped bottom 219 to the aerosol container body 139, and the dome shaped bottom and the aerosol container may be formed from a single piece of material. The dome shaped bottom 219 may have a hole 229 that may be used to introduce a propellant into a propellant chamber 250 for pressurizing the aerosol assembly 200. Thereafter, the hole 229 is plugged to prevent the propellant from escaping. Alternatively, the dome shaped bottom 219 may be a continuous structure without a hole and the propellant gas may be introduced between the valve dome 216 and the aerosol container 214.

FIG. 2B illustrates a close up view of the top end 220 of the aerosol container 214 fully receiving the valve dome 216, rigid insert 215, and liner 212. The dome 216 includes a straight portion 211, which combines with the step 241 and tapered portion 242 of the container 214 and the step 227 of the rigid insert 215 to form a cavity 246 and a narrow passage 252. As illustrated in FIG. 2A, the soft plastic liner 212 (dashed lines) can fold inside the rigid insert 215 without wrinkling. The rigid insert 215 can slide onto the straight portion 211 of the dome 216, before the dome 216 slides into the container body 214 during assembly.

As noted above, the combination of the valve dome 216, the step 241, the tapered portion 242 of the aerosol container 214, and the step 227 of the rigid insert 215 create the cavity 246. Thus, the sealing bead 238 may be squeezed within the cavity 246 between the step 227 of the rigid insert 215 and the tapered portion 242 of the aerosol container 214, forming a seal between a product chamber 248 within liner 212 and the propellant chamber 250, between the product chamber 248 and the atmosphere, and between the propellant chamber 250 and the atmosphere. The seal is formed because, typically, the width of the cavity 246 between the step 227 of the rigid insert 215 and the tapered portion of the aerosol container 214 is less than the thickness of the sealing bead 238, thus compressing sealing bead 238. The lower rim 237 of the valve dome 216 and the step 241 of the aerosol container 214 secure the rigid insert 215, liner 212, and sealing bead 238 within the cavity 246. The liner 212 extends downward from the sealing bead 238 into the aerosol container 214 through a narrow passage 252 between the rigid insert 215 and the step 241 of the aerosol container 214. Typically, the width of passage 252 may be slightly greater than the liner thickness to prevent pinching or tearing of the liner 212 during assembly and usage of the aerosol package. The step 241 of the aerosol container 214 prevents the sealing bead 238 from being pulled into the aerosol container 214 after assembly.

After the valve dome 216, rigid insert 215, and liner 212 are seated into the top end 220 of the aerosol container 214, the valve dome 216 may be affixed to the top end 220 of the aerosol container 214. One method of affixing the valve dome 216 to the top end 220 of the aerosol container 214 is by crimping the flange 240 of the valve dome 216 with the flange 244 of the aerosol container 214. The sealing bead 238 also creates a double seal for the crimped seam, and can prevent leakage of the propellant or product to the atmosphere if the crimped seam becomes damaged. This crimping embodiment 161 is illustrated in FIG. 12B. Other methods of affixing the valve dome 216 to the aerosol container 214 may also be used.

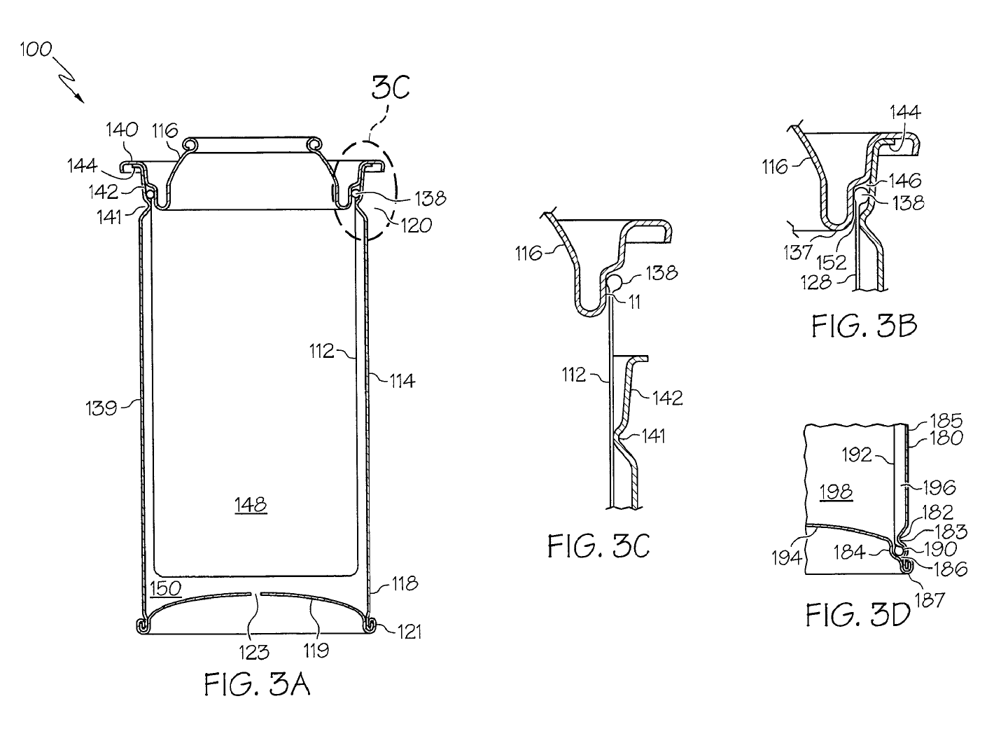

FIG. 3A illustrates another embodiment, which is similar to FIG. 2A. The aerosol package 100 of FIG. 3A has a liner 112, an aerosol container 114, and a valve dome 116. The aerosol container has a container body 139, a bottom end 118 and an opposing top end 120 configured to receive valve dome 116. The valve dome 116 contains a flange 140. FIG. 3A also illustrates a plastic liner 112 which is slightly more rigid than a flexible PVC. Because the liner 112 is more rigid, it can slide onto the dome 116 or drop into the container 114 easily during assembly. The sealing bead 138 forms a seal between the dome 116 and the container 114. The sealing bead 138 also creates a double seal for the crimped seam, and can prevent leakage of the propellant or product to the atmosphere if the crimped seam becomes damaged. The top end 120 of aerosol container 114 contains a tapered portion 142, a flange 144, and a step 141 rolled into the aerosol container as a location for receiving a sealing bead 138 of the liner 112. The bottom end 118 of the aerosol container 114 contains a dome shaped bottom 119 that is affixed to the aerosol container body 139 by a crimp 121. Other means may be used to affix the dome shaped bottom 119 to the aerosol container body 139, and the dome shaped bottom and the aerosol container may be fabricated from a single piece of material. The dome shaped bottom 119 may have a hole 123 that may be used to introduce a propellant into a propellant chamber 150 to pressurize the aerosol assembly. Thereafter, the hole 123 is plugged to prevent the propellant from escaping. Alternatively, the dome shaped bottom 119 may have a continuous structure without a hole and the propellant gas may be introduced between the valve dome 116 and the aerosol container 114.

FIG. 3B shows the partially assembled aerosol package. FIG. 3C illustrates a close up view of the top end 120 of the aerosol container 114 of FIG. 3A fully receiving the valve dome 116 and liner sub-assembly. The combination of the valve dome 116 and the step 141 and tapered neck portion 142 of the aerosol container 114 create a cavity 146. Thus, the liner bead 138 may be squeezed within the cavity 146 between the valve dome 116 and the inside surface of the tapered neck portion 142 of the aerosol container 114, forming a seal between a product chamber 148 within liner 112 and the propellant chamber 150, between the product chamber 148 and the atmosphere, and between the propellant chamber 150 and the atmosphere. The seal is formed because, typically, the width of the cavity 146 is less than the thickness of the sealing bead 138. The liner 112 extends downward from the sealing bead 138 into the aerosol container 114 through a narrow passage 152 between a lower rim 137 of the valve dome 116 and the tapered neck portion 120 of the aerosol container 114. Typically, the width of the passage 152 is slightly greater than the liner thickness to prevent pinching or tearing of the liner 112 during assembly and usage of the aerosol package.

Prior to inserting the valve dome 116 into the top end 120 of the aerosol container 114, the sealing bead 138 of the liner 112 may be slid over the lower rim 137 of the valve dome 116 and onto the valve dome 116, thereby creating a valve dome liner subassembly. Thereafter, the valve dome liner subassembly may be inserted into the top end 120 of the aerosol container 114. Alternatively, prior to inserting the valve dome 116 into the top end 120 of the aerosol container 114, the liner 112 may first be disposed in the top end 120 of the aerosol container 114 with the sealing bead 138 of the liner 112 seated against the step 141 of the aerosol container 114, thereby creating an aerosol container liner subassembly. Thereafter, the valve dome 116 may be inserted into the aerosol container liner subassembly.

The valve dome 116 may then be affixed to the top end 120 of the aerosol container 114. One method of affixing the valve dome 116 to the top end 120 of the aerosol container 114 is by crimping the flange 140 of the valve dome 116 to the flange 144 of the aerosol container 114. This crimping embodiment is illustrated in FIG. 12B. Other methods of affixing the valve dome 116 to the aerosol container 114 may also be used.

FIG. 3D shows an embodiment similar to that of FIG. 3A. The embodiment of FIG. 3D illustrates an aerosol container 185 having a step 182 for receiving a sealing bead 190 of a liner 192. A bottom dome 194 has a relief 184, which, when combined with the aerosol container body 180, creates a cavity 186. When a crimp 187 is made between the bottom dome 194 and the aerosol container body 180 is made, the sealing bead 190 may be squeezed within the cavity 186, forming a seal between product chamber 196 and propellant chamber 198, between the product chamber 196 and the atmosphere, and between the propellant chamber 198 and the atmosphere. The sealing bead 190 also creates a double seal for the crimp 187, and can prevent leakage of the propellant or product to the atmosphere if the crimp becomes damaged. The liner 192 extends upward from the sealing bead 190 into the aerosol container 185 through a narrow passageway 183 between the bottom dome 194 and the step 182. Typically, the width of passageway 183 is slightly greater than the liner thickness to prevent pinching or tearing of the liner 192 during assembly and usage of the aerosol package. Typically, a valve dome (not shown) is affixed to the top end (not shown) of the aerosol container 185, a process that would be recognized by those of ordinary skill in the art.

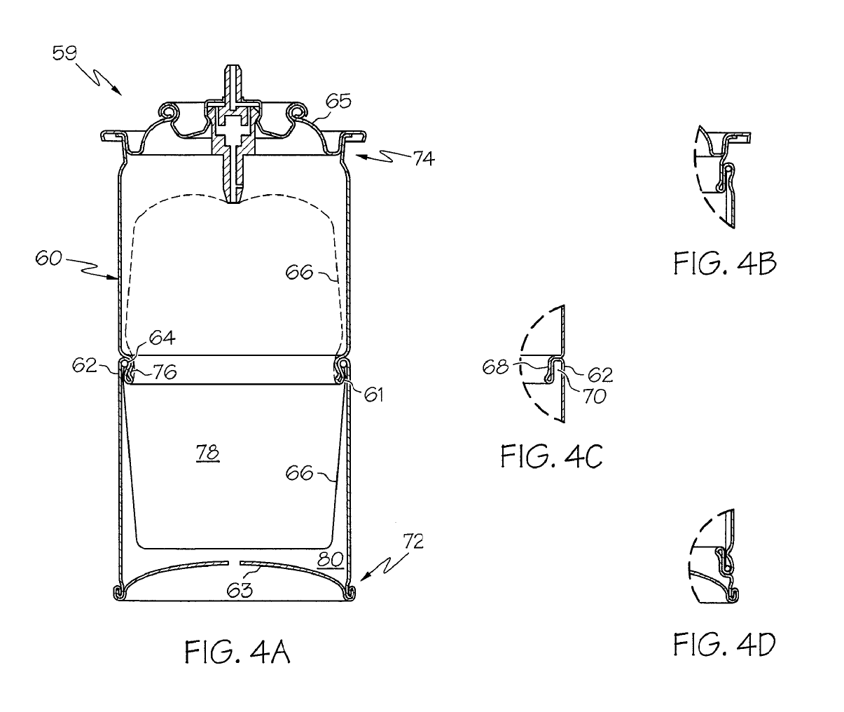

Another embodiment of the invention is shown in FIG. 4A, in which an aerosol package 59 has an aerosol container 60 containing an internal fold 62 midway of the aerosol container 60 for receiving a sealing bead 64 of a liner 66. As shown in FIG. 4C, the internal fold 62 creates a flange 68 and a cavity 70 for receiving the sealing bead 64 of the liner 66. As shown in FIG. 4A, an internal crimp 76 of the flange 68 results in the entrapment of the sealing bead 64 in the cavity 70. Thus, a seal is formed between a product chamber 78 of the liner 66 and a propellant chamber 80. The liner 66 extends from the sealing bead 64 into the aerosol container 60 through a narrow passageway 61. Typically, the width of passageway 61 is slightly greater than the liner thickness to prevent pinching or tearing of the liner 66 during assembly and usage of the aerosol package. The internal fold 62 may be located midway between a bottom end 72 and a top end 74 of the aerosol container 60, or it may be located close to the top end 74, as depicted in FIG. 4B, or close to the bottom end 72, as depicted in FIG. 4D. As illustrated, the liner 66 can travel from bottom to top (dashed lines) without wrinkling. The liner 66 can be tapered from the large open end at the bead 64 to the small closed end. This will allow the liners to be stacked for easy shipping. The bottom dome 63 of aerosol package 59 may be affixed and configured similar to that described in the embodiment of FIG. 1A, and the aerosol package 59 may be charged with propellant in a manner similar to that described in the embodiment of FIG. 1A. The valve dome 65 may be affixed to the aerosol container 60 in a manner similar to that described in the embodiment of FIG. 1A.

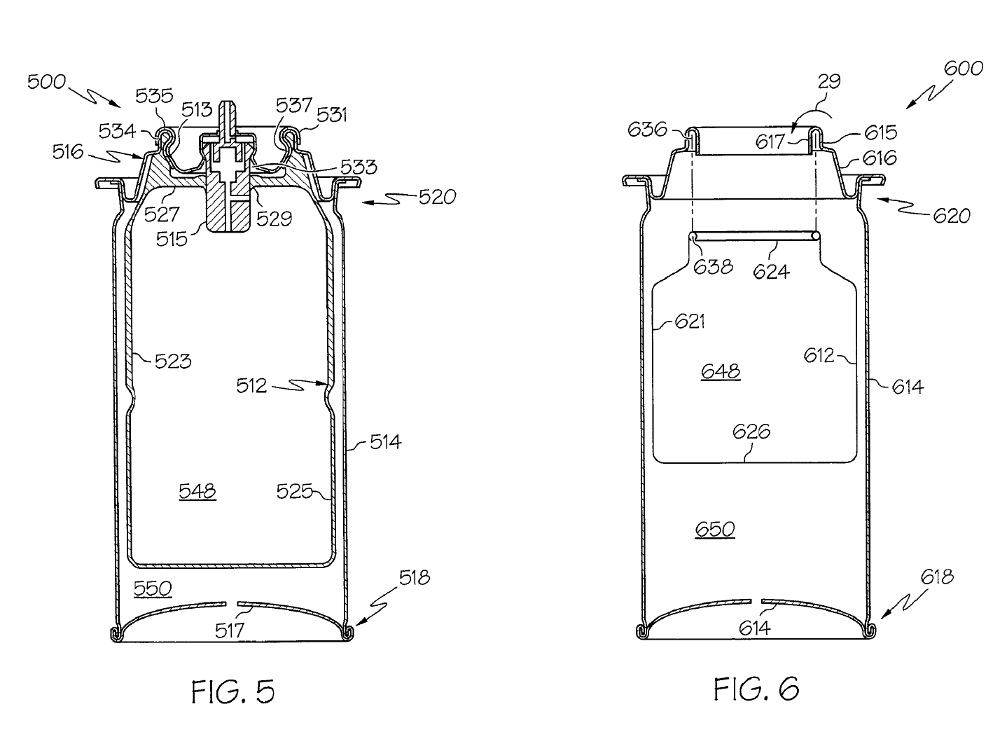

FIG. 5 illustrates another embodiment of the invention in which an aerosol package 500 has a liner 512, an aerosol container 514, a valve dome 516, a valve cup 513, and a valve body 515. The aerosol container has a bottom end 518 and an opposing top end 520 configured to receive the valve dome 516. The liner 512 has a thicker portion 523, and a thinner portion 525, whereby the thinner portion 525 may fold into the thicker portion 523 without wrinkling as the product is released from a product chamber 548 via the valve body 515.

The liner 512 contains a first sealing end 527, which has a sealing bead 534 and an opening 529. The valve dome 516 has a rolled groove 531 for receiving the sealing bead 534 of the liner 512. Typically, the diameter of the opening 529 is less than the diameter of the valve body 515, thereby providing a seal between the product chamber 548 and a cup cavity 533 when the valve body 515 is disposed in the opening 529. The valve cup 513 has a rolled groove 535 for receiving the rolled groove 531 of the valve dome 516. An inside crimp 537 crimps the rolled groove 535 of the valve cup 513 to the rolled groove 531 of the valve dome 516 and secures the sealing bead 534 inside the rolled groove 531 of the valve dome 516, thereby providing a seal between a propellant chamber 550 and the cup cavity 533. The bottom dome 517 of aerosol package 500 may be affixed and configured similar to that described in the embodiment of FIG. 1A, and the aerosol package 500 may be charged with propellant in a manner similar to that described in the embodiment of FIG. 1A. Additionally, the valve dome 516 may be affixed to the aerosol container 514 in a manner similar to that described in the embodiment of FIG. 1A.

FIG. 6 illustrates another embodiment of the invention in which an aerosol package 600 has a liner 612, an aerosol container 614, and a valve dome 616. The aerosol container 614 has a bottom end 618 and an opposing top end 620 configured to receive valve dome 616. The liner 612 comprises a first end 626, a second end 624, and a liner body 621 disposed therebetween. The first end 626 of the liner 612 has an opening and a top edge that includes a sealing bead 638. An upper rim 615 and inner flange 617 of valve dome 616 define a cavity 636 for receiving the sealing bead 638 of the liner 612. After insertion of the sealing bead 638 into valve dome 616 groove 636, an inside crimp made to turn inwardly along arrow 29, similar to the inside crimp 537 of FIG. 5, may be completed on flange 617 to seal the cavity 636, forming a seal between a product chamber 648 and a propellant chamber 650, between the product chamber 648 and the atmosphere, and between the propellant chamber 650 and the atmosphere. The bottom dome 619 of aerosol package 600 may be affixed and configured similar to that described in the embodiment of FIG. 1A, and the aerosol package 600 may be charged with propellant in a manner similar to that described in the embodiment of FIG. 1A. The valve dome 616 may be affixed to the aerosol container 614 in a manner similar to that described in the embodiment of FIG. 1A.

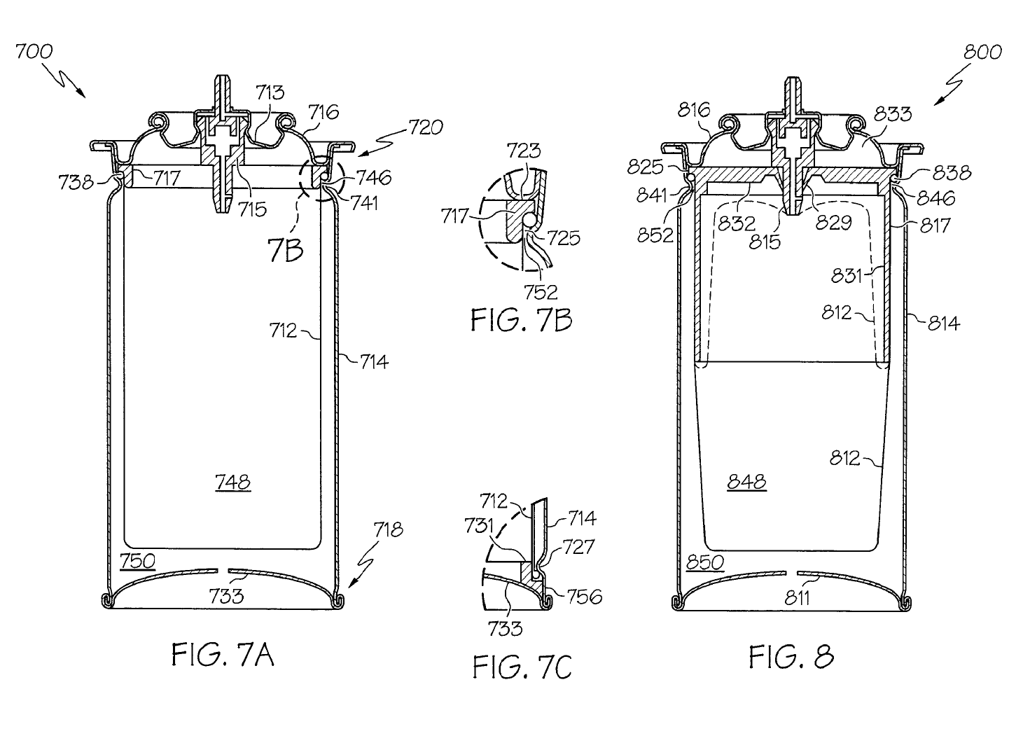

FIG. 7A illustrates another embodiment of the invention, similar to the embodiment shown in FIG. 2A, in which an aerosol package 700 has a liner 712, an aerosol container 714, a rigid insert ring 717, a valve dome 716, a valve cup 713, and a valve body 715. The aerosol container has a bottom end 718 and an opposing top end 720 configured to receive valve dome 716 and the rigid insert ring 717. The aerosol container 714 contains a step 741 rolled into the aerosol container as a location for receiving a sealing bead 738 of the liner 712.

FIG. 7B illustrates a cross-section of the rigid insert ring 717. The rigid insert ring 717 has a top end 723 and a step 725 for receiving the sealing bead 738 of the liner 712. The combination of the valve dome 716, the aerosol container step 741, and the rigid insert ring step 725 create a cavity 746. Thus, the liner bead 738 may be squeezed within the cavity 746 between the rigid insert ring step 725 and the aerosol container step 741, forming a seal between a product chamber 748 within liner 712 and a propellant chamber 750 of the aerosol assembly 700. Crimping the valve dome 716 to the aerosol container 714, in a manner similar to that described in the embodiment of FIG. 1A, secures the rigid insert ring 717 in place and maintains the seal between the product chamber 748 and the propellant chamber 750, between the product chamber 748 and the atmosphere, and between the propellant chamber 750 and the atmosphere.

The valve dome 716 and the step 741 of the aerosol container 714 secure the rigid insert 717, liner 712, and sealing bead 738 within the cavity 746. The liner 712 extends downward from the sealing bead 738 into the aerosol container 714 through a narrow passage 752 between the rigid insert 717 and the step 741 of the aerosol container 714. Typically, the width of the passage 752 may be slightly greater than the liner thickness to prevent pinching or tearing of the liner 712 during assembly and usage of the aerosol package. The step 741 of the aerosol container 714 and the step 725 of the rigid insert 717 prevent the sealing bead 738 from being pulled into the aerosol container 714 after assembly.

The bottom dome 733 of aerosol package 700 may be affixed and configured similar to that described in the embodiment of FIG. 1A, and the aerosol package 700 may be charged with propellant in a manner similar to that described in the embodiment of FIG. 1A.

Alternatively, similar to FIG. 7A and as illustrated in FIG. 7C, a rigid plastic insert ring 731 can be placed on a bottom end 756 of the container 714. A seal between the product chamber and the propellant chamber may be accomplished by rolling a step 727 at the bottom end 756 of an aerosol container 714. The combination of the liner 712, the rigid insert ring 731, and a dome shaped bottom 733 form a seal.

FIG. 8 shows an embodiment of an aerosol package 800 combining the embodiments illustrated in and described for FIGS. 2, 5, and 7A. A rigid insert 817 contains a rigid cylindrical portion 831 that extends approximately midway into the aerosol container 814. Similar to FIG. 7A, the combination of the valve dome 816 with the step 841 of the container 814 and the step 825 of the rigid insert 817 forms the cavity 246. Thus, a sealing bead 838 of the liner 812 can be squeezed within the cavity 846 between the rigid insert ring step 825 and the aerosol container step 841, forming a seal between a product chamber 848 of liner 812 and a propellant chamber 850, between the product chamber 848 and the atmosphere, and between the propellant chamber 850 and the atmosphere. The liner 812 extends downward from the sealing bead 838 into the aerosol container 814 through a narrow passage 852 between the rigid insert 817 and the step 841 of the aerosol container 814. Typically, the width of the passage 852 may be slightly greater than the liner thickness to prevent pinching or tearing of the liner 812 during assembly and usage of the aerosol package. The step 841 of the aerosol container 814 and the step 825 of the rigid insert 817 prevent the sealing bead 838 from being pulled into the aerosol container 814 after assembly.

The rigid insert 817 has an opening 829 for a valve body 815, wherein the diameter of the opening 829 is typically less than the diameter of a valve body 815, providing a seal between the product chamber 848 and a cup cavity 833 when the opening 829 receives the valve body 815. As illustrated in FIG. 8, the soft plastic liner 812 (dashed lines) can fold inside the rigid insert 215 without wrinkling.

Crimping the valve dome 816 to the aerosol container 814, in a manner similar to that described in the embodiment of FIG. 1A, secures the rigid insert 817 in place and maintains the seal between the product chamber 848 and the propellant chamber 850, between the product chamber 848 and the atmosphere, and between the propellant chamber 850 and the atmosphere.

The bottom dome 811 of aerosol package 800 may be affixed and configured similar to that described in the embodiment of FIG. 1A, and the aerosol package 800 may be charged with propellant in a manner similar to that described in the embodiment of FIG. 1A.

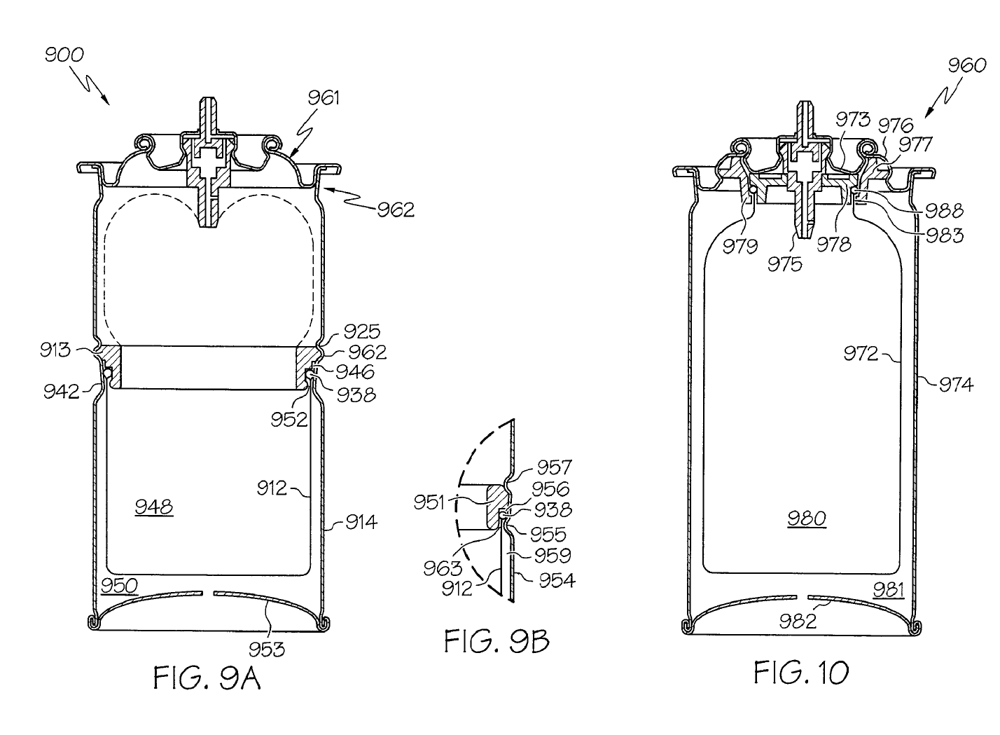

Another embodiment is shown in FIG. 9A, in which an aerosol container 914 contains a tapered portion 942 midway down the aerosol container 914 for receiving a rigid plastic insert ring 913 and a sealing bead 938 of a liner 912. The combination of the rigid insert 913 and the tapered portion 942 creates a cavity 946 for receiving the sealing bead 938 of the liner 912. The cavity 946 may be narrower than the sealing bead 938, thus creating a seal between a product chamber 948 and a propellant chamber 950. Roll 925 may be formed to secure the rigid insert 913 in the aerosol container 914. The liner 912 extends downward from the sealing bead 938 into the aerosol container 914 through a narrow passage 952 between the rigid insert 913 and the tapered portion 942 of the aerosol container 914. Typically, the width of the passage 952 may be slightly greater than the liner thickness to prevent pinching or tearing of the liner 912 during assembly and usage of the aerosol package. The tapered portion 942 of the aerosol container 914 and the rigid insert 913 prevent the sealing bead 938 from being pulled into the aerosol container 914 after assembly.

The bottom dome 953 of an aerosol package 900 may be affixed and configured similar to that described in the embodiment of FIG. 1A, and the aerosol package 900 may be charged with propellant in a manner similar to that described in the embodiment of FIG. 1A. Typically, a valve dome 961 is affixed to the top end 962 of the aerosol container 914, a process that would be recognized by those of ordinary skill in the art.

Another embodiment is shown in FIG. 9B, in which an aerosol container 914 contains a step 955 midway of the aerosol container 954 for receiving a rigid insert 951 and the sealing bead 938 of the liner 912. The combination of the rigid insert 951 and the step 955 creates a cavity 956 for receiving the sealing bead 938 of the liner 912. The cavity 956 may be narrower than the sealing bead 938, thus creating a seal between a product chamber 958 and a propellant chamber 959. Roll 957 may be formed to secure the rigid insert 951 in the aerosol container 954. The liner 912 passes through a narrow passage 963 similar to that described for the embodiment of FIG. 9A, the valve dome (not shown) and dome bottom (not shown) may be installed as described for the embodiment of FIG. 9A, and the aerosol package of FIG. 9B may be charged similar to that described for the embodiment of FIG. 9A.

FIG. 10 illustrates an embodiment in which the aerosol package 960 has a liner 972, an aerosol container 974, a valve dome 976, a valve cup 973, a valve body 975, a first rigid insert 977, and a second rigid insert 978. The liner 972 contains a sealing bead 988. The first rigid insert 977 and the second rigid insert 978 define a cavity 979 for receiving the sealing bead 988. The cavity 979 may be narrower than the sealing bead 988, thus creating a seal between a product chamber 980 and a propellant chamber 981. The liner 972 extends downward from the sealing bead 988 into the aerosol container 974 through a narrow passage 983 between the first rigid insert 977 and second rigid insert 978. Typically, the width of the passage 983 may be slightly greater than the liner thickness to prevent pinching or tearing of the liner 972 during assembly and usage of the aerosol package.

The bottom dome 982 of the aerosol package 960 may be affixed and configured similar to that described in the embodiment of FIG. 1A, and the aerosol package 960 may be charged with propellant in a manner similar to that described in the embodiment of FIG. 1A.

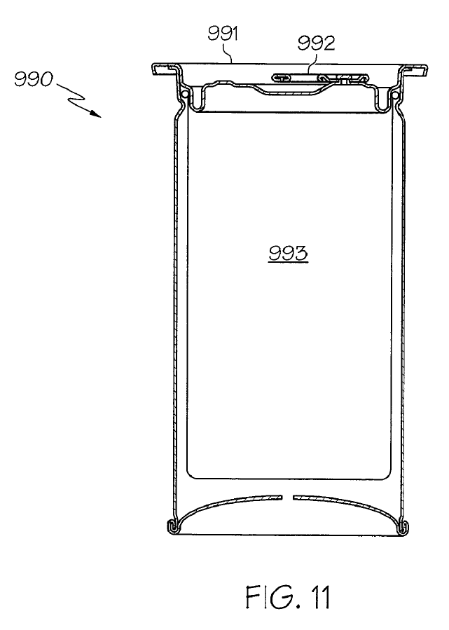

An embodiment similar to that shown in FIG. 3A is illustrated in FIG. 1. A lined can assembly 990 in FIG. 11 substitutes a flat top 991 substituted for the valve dome 116 of FIG. 3A. The lined can assembly 990 may be pressurized, as with an aerosol can. Alternatively, the lined can assembly 990 may utilize a pull tab 992 for dispensing the contents of a product chamber 993, as with, for example, a juice can.

FIG. 12A illustrates a modified valve dome 160 that may be used with the embodiment of FIG. 3A. A sealing section 162 of the valve dome 160 and a top end 168 of the aerosol container 166 create a cavity 170 for receiving the sealing bead 174 of the liner 172. The valve dome 160 has a sloped step 164, which typically creates an angle α of between 30 and 60 degrees from vertical, more typically between 40 and 50 degrees from vertical, and most typically 45 degrees from vertical. One may find that with a valve dome with the configuration described above, increasing pressure in the aerosol package forces the valve dome upward, thereby increasing the angle α.

The results of internally pressurizing an aerosol container to approximately 350 psi is illustrated in FIG. 12B. The resultant increase in the angle α (from approximately 45 degrees to between 55 degrees and 65 degrees) may result in the sealing section 162 of the valve dome 160 moving outward, reducing the width of the cavity. The reduction in cavity width squeezes a liner 172 sealing bead 174 more tightly, and increasing seal tightness between a product chamber 176 and a propellant chamber 178.

During one typical assembly process of the aerosol package 10 illustrated in FIG. 1A, the liner 12 is placed on the valve dome 16 by stretching the bead 38 of the liner 12 and disposing it in the groove 36 of the valve dome 16. The valve dome and liner assembly may then be inserted into the top end 20 of aerosol container 14. After the valve dome and liner assembly is seated into the top end 20 of the aerosol container 14 (at which time the seal between the product chamber 48 and propellant chamber 50 has been made), the valve dome 16 is affixed to the top end 20 of the aerosol container 14. One method of affixing the valve dome 16 to the top end 20 of the aerosol container 14 is by crimping the flange 40 of the valve dome 16 with the flange 42 of the aerosol container 40. This crimping embodiment is illustrated in FIG. 12B.

During one typical assembly process of the aerosol package illustrated in FIG. 3A, the liner 112 is placed on the valve dome 116 by sliding the sealing bead 138 of the liner 112 onto the valve dome 116, as illustrated in FIG. 3B. The valve dome and liner subassembly may then be inserted into the aerosol container. FIG. 3B shows the partially assembled aerosol package. FIG. 3C illustrates the top end 120 of the aerosol container 114 having fully received the valve dome 116 and liner 112. After the valve dome and liner is seated into the top end 120 of the aerosol container 114, the valve dome 116 is affixed to the top end 120 of the aerosol container 114. One method of affixing the valve dome 116 to the top end 120 of the aerosol container 114 is by crimping the flange 140 of the valve dome 116 with the flange 144 of the aerosol container 114. This crimping embodiment is illustrated in FIG. 12B.

During another typical assembly process of the aerosol package illustrated in FIG. 3A, the liner 112 may be placed in the aerosol container 114 so that the sealing bead 138 seats against the step 141 of the aerosol container 114. The valve dome 116 may then be inserted into the aerosol container-liner subassembly. FIG. 3B shows the partially assembled aerosol package. FIG. 3C illustrates the top end 120 of the aerosol container 114 having fully received the valve dome 116 and liner 112. After the valve dome and liner is seated into the top end 120 of the aerosol container 114, the valve dome 116 is affixed to the top end 120 of the aerosol container 114. One method of affixing the valve dome 116 to the top end 120 of the aerosol container 114 is by crimping the flange 140 of the valve dome 116 with the flange 144 of the aerosol container 114. This crimping embodiment is illustrated in FIG. 12B.

While the present invention has been illustrated by the description of embodiments thereof, and while the embodiments have been described in considerable detail, it is not intended to restrict or in any way limit the scope of the appended claims to such detail. Additional advantages and modifications will be readily apparent to those skilled in the art. The invention in its broader aspects is therefore not limited to the specific details, representative apparatus and method, and illustrated examples shown and described. Accordingly, departures may be made from such details without departing from the scope or spirit of the invention.

What is claimed is:

1. An aerosol package, comprising:
(a) an aerosol container comprising a bottom end and an opposing top end, the opposing top end configured to receive a valve dome;
(b) a liner comprising a first end, a second end, and a liner body disposed therebetween, wherein the first end has an opening and a top edge that includes a sealing bead which is thicker than the liner body and wherein said liner is disposed in said aerosol container; and
(c) a valve dome disposed in said top end of said aerosol container.

2. The aerosol package according to claim 1, wherein said sealing bead is disposed between said valve dome and said aerosol container.

3. The aerosol package according to claim 1, wherein said valve dome has an opening for receiving a valve cup.

4. The aerosol package according to claim 1, wherein said valve dome includes a groove for receiving said sealing bead of said liner.

5. The aerosol package according to claim 2, wherein said valve dome further includes a groove for receiving said sealing bead of said liner.

6. The aerosol package according to claim 1, wherein said top end of said aerosol container defines a location for receiving said sealing bead of said liner.

7. The aerosol package according to claim 1, further comprising means for receiving said sealing bead substantially midway between said top end and said bottom end of said aerosol container.

8. The aerosol package according to claim 2, wherein said top end of said aerosol container is tapered.

9. The aerosol package according to claim 1, wherein said valve body defines a sloped step, said step creating an angle α between 30 and 60 degrees from vertical.

10. The aerosol package according to claim 1, wherein said valve dome defines a sloped step, said step creating an angle α between 40 and 50 degrees from vertical.

11. The aerosol package according to claim 2, wherein said valve dome defines a sloped step, said step creating an angle α between 30 and 60 degrees from vertical.

12. The aerosol package according to claim 2, wherein said valve dome defines a sloped step, said step creating an angle α between 40 and 50 degrees from vertical.

13. The aerosol package according to claim 1, wherein said bead is disposed within a cavity adapted to receive said bead, said cavity formed by the combination of the valve dome and the aerosol container.

14. The aerosol package according to claim 1, further comprising a valve body.

15. The aerosol package according to claim 14, further comprising a valve cup.

16. A method for assembling an aerosol package, the method comprising the steps of:
(a) providing a sub-assembly comprising an aerosol container and a liner disposed therein,
i) said aerosol container comprising a bottom end and an opposing top end,
ii) said liner comprising a first end, a second end, and a liner body disposed therebetween, wherein the first end has an opening and a top edge that includes a sealing bead which is thicker than the liner body;
(b) providing a valve dome;
(c) inserting said valve dome into the open end of said liner and top end of said aerosol container, wherein said sealing bead of said liner is squeezed between said valve dome and said aerosol container, thereby establishing a seal between said valve dome and said aerosol container; and
(d) affixing said valve dome to said aerosol container.

17. A method for assembling an aerosol package, the method comprising the steps of:
(a) providing a sub-assembly comprising a valve dome and a liner disposed thereon,
i) said liner comprising a first end, a second end, and a liner body disposed therebetween, wherein the first end has an opening and a top edge that includes a sealing bead which is thicker than said liner body;
(b) providing an aerosol container comprising a bottom end and an opposing top end, the opposing top end configured to receive said valve dome and said liner;
(c) inserting said valve dome and liner subassembly into said top end of said aerosol container, wherein said sealing bead of said liner is squeezed between said valve dome and said aerosol container thereby establishing a seal between said valve dome and said aerosol container; and
(d) affixing said valve dome with said aerosol container.

18. The method according to claim 17, wherein said valve dome has a groove for receiving said sealing bead of said liner.
